(19) United States
(12) Patent Application Publication
(10) Pub. No.: US 2011/0065039 A1
(43) Pub. Date: Mar. 17, 2011

(54) TONER BINDER AND TONER

(75) Inventors: Koji Ota, Kyoto (JP); Shogo Ejiri, Kyoto (JP)

(73) Assignee: SANYO CHEMICAL INDUSTRIES, LTD., Kyoto-shi, Kyoto (JP)

(21) Appl. No.: 12/934,508

(22) PCT Filed: Mar. 27, 2009
(86) PCT No.: PCT/JP2009/001379

§ 371 Date: Sep. 24, 2010

(30) Foreign Application Priority Data
Mar. 31, 2008 (JP) 2008-093827
Feb. 19, 2009 (JP) 2009-036286

(51) Int. Cl. G03G 9/087; C08G 81/00; C08F 220/10

(52) U.S. Cl. 430/109.3; 430/109.5; 525/452; 526/318.44

(57) ABSTRACT

A toner excellent in low temperature fixability and blocking resistance, and a toner binder are provided. The present invention is a toner binder containing a crystalline resin (A) having a maximum peak temperature of heat of fusion (Ta) of 40 to 100° C., a ratio between the softening point and Ta (softening point/Ta) ranging from 0.8 to 1.55, and a melting start temperature (X) within a temperature range of (Ta±30)° C., and satisfying the following requirements; and a toner containing the toner binder and a coloring agent:
[Requirement 1] G′(Ta+20)=50 to 1×10⁶ [Pa]
[Requirement 2] |log G″(X+20)−log G″(X)|>2.0
[G′: storage elastic modulus [Pa], G″: loss elastic modulus [Pa]].

### TECHNICAL FIELD

The present invention relates to a toner binder, and a toner using the same.

### BACKGROUND ART

Conventionally, a technique of fixing a toner with low energy is desired. Hence, there is a strong demand for a toner for electrostatic charge development capable of being fixed at a lower temperature.

As a measure for lowering the fixing temperature of a toner, a technique of lowering the glass transition point of a toner binder is commonly employed. However, if the glass transition point is made too low, aggregation (blocking) of a powder is more likely to occur, and the storage property of the toner on the fixed image surface is impaired, so that the practical lower limit is 50° C. This glass transition point is a designing point of a toner binder, and a toner that enables fixing at a temperature lower than that currently achieved has not been obtained by a method of lowering the glass transition point.

As a measure for achieving both blocking prevention and low temperature fixability, a method using a crystalline resin as a toner binder is traditionally known. This method, however, has a problem that hot offset occurs due to shortage of elasticity at the time of melting.

Also as a measure for achieving both blocking prevention and low temperature fixability, a toner having a shell obtained by using a melt suspension method or an emulsion aggregation method is proposed (see for example, Patent Documents 1 and 2). However, these techniques are still insufficient for obtaining good blocking resistance while keeping the low temperature fixation.

Patent Document 1: Japanese Patent Application Laid-Open (JP-A) No. 2007-70621

Patent Document 2: JP-A No. 2004-191927

### DISCLOSURE OF INVENTION

### Problems to be Solved by the Invention

The present invention aims at solving the above problems of the conventional techniques. That is, it is an object of the present invention to provide a toner, and a toner binder that are excellent in low temperature fixability and blocking resistance.

### Solution to the Problems

The above object is achieved by the present invention as described in the following.

That is, the present invention provides a toner binder containing a crystalline resin (A) having a maximum peak temperature of heat of fusion (Ta) of 40 to 100° C., a ratio between the softening point and Ta (softening point/Ta) of 0.8 to 1.55, and a melting start temperature (X) within a temperature range of (Ta±30)° C., and satisfying the following requirements; and a toner containing the above toner binder and a coloring agent.

[Requirement 1] G′(Ta+20)=50 to 1×10⁶ [Pa]

[Requirement 2] |log G″(X+20)−log G″(X)|>2.0

[G′: storage elastic modulus [Pa], G″: loss elastic modulus [Pa]]

### ADVANTAGES OF THE INVENTION

According to the present invention, it is possible to provide a toner and a toner binder that are excellent in low temperature fixability and blocking resistance.

### BEST MODE FOR CARRYING OUT THE INVENTION

In the following, details of a toner binder of the present invention will be described.

The toner binder of the present invention contains a crystalline resin (A).

In the present invention, the term “crystalline” represents that a ratio between the softening point and a maximum peak temperature of heat of fusion (Ta) (softening point/Ta) is 0.8 to 1.55, and a clear endothermic peak rather than a stepwise change in the endothermic amount is observed in differential scanning calorimetry (DSC). Meanwhile, the term “noncrystalline” represents that a ratio between the softening point and a maximum peak temperature of heat of fusion (softening point/Ta) is more than 1.55.

Even if the resin is a blocked body of a crystalline resin and a noncrystalline resin, it is regarded as a crystalline resin as far as a clear endothermic peak is observed in differential scanning calorimetry (DSC) and a ratio between the softening point and a maximum peak temperature of heat of fusion (Ta) is 0.8 to 1.55.

From the viewpoint of the heat resistant storage property, the crystalline resin (A) has a maximum peak temperature of heat of fusion (Ta) ranging from 40 to 100° C., preferably from 45 to 80° C., and more preferably from 50 to 70° C.

A ratio between the softening point and a maximum peak temperature of heat of fusion (Ta) (softening point/Ta) of the crystalline resin (A) is from 0.8 to 1.55 as described above, and when the ratio is outside this range, an image is more likely to deteriorate. It is preferably 0.85 to 1.2, and more preferably 0.9 to 1.15.

The softening point, and the maximum peak temperature of heat of fusion (Ta) are values measured in the following manner.

### <Softening Point>

Using a descending type flow tester {for example, CFT-500D manufactured by Shimadzu Corporation}, 1 g of a measurement sample is pushed through a nozzle having a diameter of 1 mm and a length of 1 mm by application of a load of 1.96 MPa by means of a plunger while it is heated at a temperature elevation rate of 6° C./min., and a graph of the “plunger descending amount (flow value)” and the “temperature” is drawn. The temperature corresponding to ½ of the maximum value of the descending amount of the plunger is read from the graph, and the value (a temperature at which half of the measurement sample has flowed out) is determined as the softening point.

### <Maximum Peak Temperature of Heat of Fusion (Ta)>

A differential scanning calorimeter (DSC) {for example, DSC210 manufactured by Seiko Instruments Inc.} is used for measurement.

A sample subjected to measurement of (Ta) is, as a pretreatment, melted at 130° C., and allowed to cool from 130° C. to 70° C. at a rate of 1.0° C./min., and allowed to cool from 70° C. to 10° C. at a rate of 0.5° C./min. At this point, endothermic or exothermic change is measured by DSC by elevating the temperature at a temperature elevation rate of 20° C./min., and a graph of the “endothermic or exothermic heat quantity” and the “temperature” is drawn, and the endothermic peak temperature within the range of 20° C. to 100° C. observed at this time is determined as Ta'. When there are a plurality of peaks, the temperature of the peak at which the endothermic heat quantity is greatest is determined as Ta'. Lastly, the sample is stored at (Ta′−10)° C. for 6 hours, and then stored at (Ta′−15)° C. for 6 hours.

Next, after cooling the above sample to 0° C. at a temperature decrease rate of 10° C./min., and the endothermic or exothermic change is measured by DSC by elevating the temperature at a temperature elevation rate of 20° C./min., and a graph is drawn similarly. A temperature corresponding to the maximum peak of the endothermic or exothermic heat quantity is determined as the maximum peak temperature of heat of fusion (Ta).

In viscoelasticity characteristics of the crystalline resin (A), the storage elastic modulus G′ at (Ta+20)° C. (Ta is the maximum peak temperature of heat of fusion) falls within the range of 50 to 1×10⁶ [Pa] [Requirement 1], and preferably within the range of 100 to 5×10⁵ [Pa].

When G′ at (Ta+20)° C. is less than 50 Pa, hot offset occurs even at the time of fixation at low temperature, and a fixing temperature region is narrowed. When it is more than 1×10⁶ [Pa], a viscosity enabling fixing at low temperature is difficult to be obtained, so that fixability at low temperature is impaired.

In the present invention, the dynamic viscoelasticity measurement values (storage elastic modulus G′, loss elastic modulus G″) are measured using a dynamic viscoelasticity measuring apparatus RDS-2 manufactured by Rheometric Scientific at a frequency of 1 Hz.

After a measurement sample is set in a jig of the measuring apparatus, the temperature is elevated to (Ta+30)° C. to make the sample be closely adhered to the jig, and then the temperature is decreased from (Ta+30)° C. to (Ta−30)° C. at a rate of 0.5° C./min., followed by leaving still at (Ta−30)° C. for 1 hour, and then the temperature is decreased to (Ta−10)° C. at a rate of 0.5° C./min., followed by leaving still at (Ta−10)° C. for 1 hour to make crystallization sufficiently proceed, and measurement is conducted using the resultant crystal. The measurement temperature ranges from 30° C. to 200° C., and by measuring the binder melt viscoelasticity within these temperatures, curves of temperature−G′ and temperature−G″ can be obtained.

The crystalline resin (A) satisfying [Requirement 1] can be obtained, for example, by adjusting the percentage of the crystalline component in (A) and adjusting the molecular weight. For example, when the a percentage of the crystalline part (b) as will be described later or the percentage of the crystalline component is increased, the value of G′(Ta+20) decreases. As the crystalline component, polyols, polyisocyanates and the like having a straight-chain structure can be recited. Also by decreasing the molecular weight, the value of G′(Ta+20) is decreased.

The melting start temperature (X) of the crystalline resin is within a temperature range of (Ta±30)° C., preferably within a temperature range of (Ta±20)° C., and more preferably within a temperature range of (Ta±15)° C. Concretely, (X) is preferably 30 to 100° C., and more preferably 40 to 80° C. The melting start temperature (X) is a value measured in the following manner.

### <Melting Start Temperature>

Using a descending type flow tester {for example, CFT-500D manufactured by Shimadzu Corporation}, 1 g of a measurement sample is pushed through a nozzle having a diameter of 1 mm and a length of 1 mm by application of a load of 1.96 MPa by means of a plunger while it is heated at a temperature elevation rate of 6° C./min., and a graph of the “plunger descending amount (flow value)” and the “temperature” is drawn. The temperature at which the piston clearly starts descending again after slight elevation of the piston due to heat expansion of the sample is read from the graph, and the value is determined as the melting start temperature.

Concerning the loss elastic modulus G″ and the melting start temperature (X), the crystalline resin (A) satisfies essentially [Requirement 2], preferably [Requirement 2-2], and more preferably [Requirement 2-3] as described in the following.

[Requirement 2] |log G″(X+20)−log G″(X)|>2.0

[G′: storage elastic modulus [Pa], G″: loss elastic modulus [Pa]]

[Requirement 2-2] |log G″(X+20)−log G″(X)|>2.5

[Requirement 2-3] |log G″(X+15)−log G″(X)|>2.5

When the melting start temperature (X) of the crystalline resin (A) falls within the above range, and [Requirement 2] is satisfied, the viscosity decrease rate of the resin is high, so that it is possible to obtain equivalent image quality on both the low temperature side and the high temperature side of the fixing temperature region. Further, the time required to reach a fixable viscosity from the start of melting is short, so that it is advantageous for obtaining excellent low temperature fixability. [Requirement 2] is an index of the sharp melting property of the resin, namely, how quickly and with how little heat the fixing is achieved, which has been determined experimentally.

The crystalline resin (A) satisfying the range of the melting start temperature (X) and [Requirement 2] can be obtained, for example, by adjusting the percentage of the crystalline component in constituents of (A). For example, as the percentage of the crystalline component is increased, the temperature difference between (Ta) and (X) decreases.

Resins used for conventional toner binders satisfied [Requirement 1], but not [Requirement 2] in the case of a noncrystalline resin. On the other hand, a crystalline resin satisfied [Requirement 2], but not [Requirement 1]. Therefore, there is no toner binder that contains a resin satisfying both [Requirement 1] and [Requirement 2]. The present invention is characterized by using a crystalline resin satisfying [Requirement 1] as a toner binder.

In the viscoelasticity characteristics of the crystalline resin (A), a ratio between the loss elastic modulus G″ at (Ta+30)° C. and the loss elastic modulus G″ at (Ta+70)° C. [G″(Ta+30)/G″(Ta+70)] is preferably 0.05 to 50, and more preferably 0.1 to 10 [Ta: maximum peak temperature of heat of fusion of (A)].

By keeping the ratio between loss elastic moduli within the above range, more stable image quality in the fixing temperature region can be obtained.

The crystalline resin (A) satisfying the above requirement of the ratio of G″ can be obtained, for example, by adjusting the percentage of the crystalline component in constituents of (A) or the molecular weight of the crystalline part (b) as will be described later. For example, when the percentage of the crystalline part (b) or the percentage of the crystalline component is increased, the value of [G″(Ta+30)/G″(Ta+70)] decreases. When the molecular weight of the crystalline part (b) is increased, the value of [G″(Ta+30)/G″(Ta+70)] decreases. As the crystalline component, polyols, polyisocyanates and the like having a straight-chain structure can be recited.

The crystalline resin (A) may be composed exclusively of the crystalline part (b), or composed of a block resin having the crystalline part (b) and the noncrystalline part (c) as far as it has crystallinity, however, from the viewpoint of fixability (particularly, hot offset resistance), it is preferably a block resin composed of (b) and (c).

Also, filming to a photoreceptor is less likely to occur in the case of a block resin.

In the following, details of a block resin composed of the crystalline part (b) and the noncrystalline part (c), which is a resin preferred as the crystalline resin (A), will be described.

In the case of a block resin, the glass transition point (Tg) of (c) is preferably 40 to 250° C., more preferably 50 to 240° C., particularly preferably 60 to 230° C., and most preferably 65 to 180° C. from the viewpoint of the heat resistant storage property. The softening point in the flow tester measurement of (c) is preferably 100 to 300° C., more preferably 110 to 290° C., and particularly preferably 120 to 280° C.

The glass transition point (Tg) is a value measured in the following manner.

### <Glass Transition Point (Tg)>

The glass transition point is a physical property peculiar to a noncrystalline resin, and is distinguished from the maximum peak temperature of heat of fusion. In the measurement of the above maximum peak temperature of heat of fusion (Ta), a temperature corresponding to an intersection between an extended line of a base line at a temperature equal to or lower than the maximum peak temperature in the graph of the “endothermic or exothermic heat quantity” and the “temperature”, and a tangent indicating a maximum slope from a rising part of the maximum peak to the apex of the maximum peak is determined as the glass transition point.

The weight average molecular weight (hereinafter, referred to as Mw) of the crystalline resin (A) is preferably 5000 to 100000, more preferably 6000 to 89000, and particularly preferably 8000 to 50000 from the viewpoint of fixing.

When (A) is a block resin having the crystalline part (b) and the noncrystalline part (c), the Mw of (b) is preferably 2000 to 80000, more preferably 4000 to 60000, and particularly preferably 7000 to 30000.

The Mw of (c) is preferably 500 to 50000, more preferably 750 to 20000, and particularly preferably 1000 to 10000.

In the present invention, the molecular weight of a resin is measured under the following condition using gel permeation chromatography (GPC).

Apparatus (one example): HLC-8120 manufactured by TOSOH CORPORATION

Column (one example): TSK GEL GMH6×2 [manufactured by TOSOH CORPORATION]

Measurement temperature: 40° C.

Sample solution: 0.25% by weight THF solution

Solution injection amount: 100 μL

Detecting apparatus: Refraction index detector

Standard substance: 12 standard polystyrenes (TSK standard POLYSTYRENE) manufactured by TOSOH CORPORATION (molecular weight: 500, 1050, 2800, 9100, 18100, 37900, 96400, 190000, 355000, 1090000, 2890000)

When the crystalline resin (A) is a block resin composed of a crystalline part (b) and a noncrystalline part (c), the percentage of the crystalline part (b) in (A) is preferably 50% by weight or more, more preferably 60 to 96% by weight, and further preferably 65 to 90% by weight. When the percentage of (b) is 50% by weight or more, crystallinity of (A) is not impaired, and better low temperature fixability is realized.

When the crystalline resin (A) is a block resin composed of the crystalline part (b) and the noncrystalline part (c), each terminal of the product in which (b) and (c) are linearly bound in the following form is the resin of (b), and an average value n of the number of repetition of the unit {−(c)−(b)} is preferably 0.9 to 3.5, more preferably n=0.95 to 2.0, and particularly preferably n=1.0 to 1.5.

(b){−(c)−(b)}n

The above formula concretely means a resin in which the crystalline part (b) and the noncrystalline part (c) are bound linearly in the form of (b) [n=0], (b)−(c)−(b) [n=1], (b)−(c)−(b)−(c)−(b)[n=2], (b)−(c)−(b)−(c)−(b)−(c)−(b)[n=3] or the like, and a mixture thereof [excluding the one composed only of units in which n=0].

When n is 3.5 or less, crystallinity of the crystalline resin (A) is not impaired. When n is 0.9 or more, elasticity of (A) after melting is good, and hot offset is less likely to occur during fixing, and the fixing temperature region is further extended. Here, “n” is a calculated value determined from use amounts of raw materials [the molar ratio between (b) and (c)]. From the viewpoint of degree of crystallinity of the crystalline resin (A), each terminal of (A) is preferably the crystalline part (b).

When both terminals are the noncrystalline part (c), it is preferred to make the percentage of the crystalline part (b) in (A) 75% by weight or more to impart crystallinity to the crystalline resin (A) because the degree of crystallinity is impaired.

The resin used for the crystalline part (b) will be described.

The resin used for the crystalline part (b) is not particularly limited as far as it has crystallinity. From the viewpoint of the heat resistant storage property, the melting point is preferably within the range of 40 to 100° C. (more preferably within the range of 50 to 70° C.). The melting point is measured by a differential scanning calorimeter {for example, DSC210 manufactured by Seiko Instruments Inc.} likewise the maximum peak temperature of heat of fusion (Ta).

The crystalline part (b) is not particularly limited as far as it has crystallinity, and may be a composite resin. Above all, a polyester resin, a polyurethane resin, a polyurea resin, a polyamide resin, a polyether resin and composite resins thereof are preferred, and a straight-chain polyester resin and composite resins containing the same are particularly preferred.

As the polyester resin used as (b), a polycondensation polyester resin synthesized from an alcohol (diol) component and an acid (dicarboxylic acid) component is preferred from the viewpoint of crystallinity. However, a tri- or more functional alcohol component or a tri- or more functional acid component may be used as necessary.

As the polyester resin, a lactone ring-opening polymer and a polyhydroxycarboxylic acid are equally preferred besides the polycondensation polyester resin.

As the polyurethane resin, a polyurethane resin synthesized from an alcohol (diol) component and an isocyanate (diisocyanate) component, and the like can be recited. However, a tri- or more functional alcohol component or a tri- or more functional isocyanate component may be used as necessary.

As the polyamide resin, a polyamide resin synthesized from an amine (diamine) component and an acid (dicarboxylic acid) component, and the like can be recited. However, a tri- or more functional amine component or a tri- or more functional acid component may be used as necessary.

As the polyurea resin, a polyurea resin synthesized from an amine (diamine) component and an isocyanate (diisocyanate) component, and the like can be recited. However, a tri- or more functional amine component or a tri- or more functional isocyanate component may be used as necessary.

In the following description, first, a diol component, a dicarboxylic acid component, a diisocyanate component, and a diamine component (respectively including tri- or more functional ones) used for these crystalline polycondensation polyester resin, crystalline polyurethane resin, crystalline polyamide resin, and crystalline polyurea resin will be described individually.

[Diol Component]

As the diol component, an aliphatic diol is preferred, and the number of carbon atoms is preferably within the range of 2 to 36. A straight-chain aliphatic diol is more preferred.

When the aliphatic diol is of a branched form, crystallinity of the polyester resin deteriorates, and the melting point drops, so that toner blocking resistance, image storage stability and low temperature fixability may be impaired. When the number of carbon atoms is more than 36, it is sometimes difficult to obtain practical materials.

As to the diol component, the content of the straight-chain aliphatic diol is preferably 80% by mol or more, and more preferably 90% by mol or more of the diol component to be used. When it is 80% by mol or more, crystallinity of the polyester resin improves, and the melting point increases, so that better toner blocking resistance and low temperature fixability are realized.

Concrete examples of the straight-chain aliphatic diol include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among these, ethylene glycol, 1,3-propanediol, 1,4-butanediol, 1,6-hexanediol, 1,9-nonanediol, and 1,10-decanediol are preferred from the viewpoint of easy availability.

As other diols used as necessary, aliphatic diols with 2 to 36 carbon atoms other than those recited above (1,2-propylene glycol, butanediol, hexanediol, octanediol, decanediol, dodecanediol, tetradecanediol, neopentyl glycol, 2,2-diethyl-1,3-propanediol, and the like); alkylene ether glycols with 4 to 36 carbon atoms (diethylene glycol, triethylene glycol, dipropylene glycol, polyethylene glycol, polypropylene glycol, polytetramethylene ether glycol, and the like); alicyclic diols with 4 to 36 carbon atoms (1,4-cyclohexanedimethanol, hydrogenated bisphenol A, and the like); alkylene oxide (hereinafter, abbreviated as AO) [ethylene oxide (hereinafter, abbreviated as EO), propylene oxide (hereinafter, abbreviated as PO), butylene oxide (hereinafter, abbreviated as BO), or the like] adducts (the number of moles added 1 to 30) of the above alicyclic diols; AO (EO, PO, BO, or the like) adducts (the number of moles added 2 to 30) of bisphenols (bisphenol A, bisphenol F, bisphenol S, and the like); polylactone diols (poly ε-caprolactone diol, and the like); and polybutadiene diols, and the like can be recited.

As the other diols used as necessary, diols having other functional groups may be used. As the diol having a functional group, a diol having a carboxyl group, a diol having a sulfonic acid group or a sulfamic acid group, and salts thereof, and the like can be recited.

As the diol having a carboxyl group, a dialkylolalkane acid [C6 to 24, for example, 2,2-dimethylol propionic acid (DMPA), 2,2-dimethylol butanoic acid, 2,2-dimethylol heptanoic acid, 2,2-dimethylol octanoic acid, or the like] can be recited.

As the diol having a sulfonic acid group or a sulfamic acid group, sulfamic acid diols [N,N-bis(2-hydroxyalkyl) sulfamic acid (C1 to 6 of an alkyl group) or AO adducts thereof (AO is EO, PO, or the like, the number of moles added of AO 1 to 6): for example, N,N-bis(2-hydroxyethyl)sulfamic acid, N,N-bis(2-hydroxyethyl)sulfamic acid PO 2-mol adduct, and the like]; bis(2-hydroxyethyl)phosphate, and the like can be recited.

As a neutralization base in these diols having a neutralization base, for example, the above tertiary amines with 3 to 30 carbon atoms (triethylamine, and the like) and/or alkali metals (sodium salt, and the like) can be recited.

Among these, preferred are alkylene glycols with 2 to 12 carbon atoms, diols having a carboxyl group, AO adducts of bisphenols, and combinational use thereof.

As a 3 to 8- or more-valent polyol used as necessary, 3 to 8 or more-hydric polyhydric aliphatic alcohols with 3 to 36 carbon atoms (alkanepolyol and its intramolecular or intermolecular dehydration products, for example, glycerin, trimethylol ethane, trimethylol propane, pentaerythritol, sorbitol, sorbitan, and polyglycerin; saccharides and derivatives thereof, for example, sucrose, and methylglucoside); AO adducts (the number of moles added 2 to 30) of trisphenols (trisphenol PA, and the like); AO adducts (the number of moles added 2 to 30) of novolac resins (phenol novolac, cresol novolac, and the like); acrylic polyols [copolymers of hydroxyethyl(meth)acrylate and other vinyl monomers, and the like]; and the like can be recited.

Among these, 3 to 8- or more-hydric polyhydric aliphatic alcohols and AO adducts of novolac resins are preferred, and AO adducts of novolac resins are more preferred.

[Dicarboxylic Acid Component]

As the dicarboxylic acid component, various dicarboxylic acids can be recited, and aliphatic dicarboxylic acids and aromatic dicarboxylic acids are preferred. As the aliphatic dicarboxylic acid, a straight-chain carboxylic acid is more preferred.

As the dicarboxylic acid, alkane dicarboxylic acids with 4 to 36 carbon atoms (succinic acid, adipic acid, sebacic acid, azelaic acid, dodecane dicarboxylic acid, octadecane dicarboxylic acid, decyl succinic acid, and the like); alicyclic dicarboxylic acids with 6 to 40 carbon atoms [dimer acid (dimerized linoleic acid), and the like], alkene dicarboxylic acids with 4 to 36 carbon atoms (alkenyl succinic acids such as dodecenyl succinic acid, pentadecenyl succinic acid, and octadecenyl succinic acid, maleic acid, fumaric acid, citraconic acid, and the like); aromatic dicarboxylic acids with 8 to 36 carbon atoms (phthalic acid, isophthalic acid, terephthalic acid, t-butylisophthalic acid, 2,6-naphthalene dicarboxylic acid, 4,4′-biphenyl dicarboxylic acid, and the like) and the like can be recited.

As the dicarboxylic acid or 3 to 6- or more-valent polycarboxylic acids, acid anhydrides or lower alkyl esters with 1 to 4 carbon atoms of those described above (methyl esters, ethyl esters, isopropyl esters, and the like) may be used.

Among these dicarboxylic acids, it is particularly preferred to use an aliphatic dicarboxylic acid (a straight-chain carboxylic acid, in particular) singly, however, copolymers of aromatic dicarboxylic acids (terephthalic acid, isophthalic acid, t-butylisophthalic acid, and lower alkyl esters thereof are preferred) with aliphatic dicarboxylic acids are preferred as well. The copolymerizing amount of the aromatic dicarboxylic acid is preferably 20% by mol or less.

Principal examples of the dicarboxylic acid component include, but are not limited to, the above carboxylic acids. Among these, from the viewpoint of crystallinity and easy availability, adipic acid, sebacic acid, dodecane dicarboxylic acid, terephthalic acid, and isophthalic acid are preferred.

[Diisocyanate Component]

As the diisocyanate, aromatic diisocyanates with 6 to 20 carbon atoms (excluding carbon in the NCO group, ditto in the following), aliphatic diisocyanates with 2 to 18 carbon atoms, alicyclic diisocyanates with 4 to 15 carbon atoms, araliphatic diisocyanates with 8 to 15 carbon atoms and modified products of these diisocyanates (urethane group-, carbodiimide group-, allophanate group-, urea group-, biuret group-, urethdione group-, urethimine group-, isocyanurate group-, and oxazolidone group-containing modified products, and the like) and mixtures of two or more of these can be recited. Further, tri- or more-valent polyisocyanates may be used together as necessary.

Concrete examples of the above aromatic diisocyanate (including tri- or more-valent polyisocyanates) include 1,3- and/or 1,4-phenylene diisocyanate, 2,4- and/or 2,6-tolylene diisocyanate (TDI), crude TDI, 2,4′- and/or 4,4′-diphenylmethane diisocyanate (MDI), crude MDI [phosgenated crude diaminophenylmethane [a condensation product of formaldehyde, and an aromatic amine (aniline) or a mixture thereof; or a mixture of diaminodiphenylmethane and a small amount (for example, 5 to 20% by weight) of a tri- or more functional polyamine] polyallylpolyisocyanate (PAPI)], 1,5-naphthylene diisocyanate, 4,4′,4″-triphenylmethane triisocyanate, and m- and p-isocyanato phenylsulfonyl isocyanate.

As concrete examples of the above aliphatic diisocyanate (including tri- or more-valent polyisocyanates), ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanato methylcaproate, bis(2-isocyanatoethyl) fumarate, bis(2-isocyanatoethyl) carbonate, 2-isocyanatoethyl-2,6-diisocyanato hexanoate, and the like can be recited.

As concrete examples of the above alicyclic diisocyanate, isophorone diisocyanate (IPDI), dicyclohexymethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5- and/or 2,6-norbornane diisocyanate, and the like can be recited.

As concrete examples of the above araliphatic diisocyanate, m- and/or p-xylylene diisocyanate (XDI), α,α,α′,α′-tetramethyl xylylene diisocyanate (TMXDI), and the like can be recited.

Further, as modified products of the above diisocyanate, urethane group-, carbodiimide group-, allophanate group-, urea group-, biuret group-, urethdione group-, urethimine group-, isocyanurate group-, and oxazolidone group-containing modified products, and the like can be recited.

Concrete examples thereof include modified products of diisocyanates such as modified MDI (urethane-modified MDI, carbodiimide-modified MDI, trihydrocarbyl phosphate-modified MDI, and the like) and urethane-modified TDI and mixtures of two or more kinds of these [for example, combinational use of modified MDI and urethane-modified TDI (an isocyanate-containing prepolymer)].

Among these, aromatic diisocyanates with 6 to 15 carbon atoms, aliphatic diisocyanates with 4 to 12 carbon atoms, and alicyclic diisocyanates with 4 to 15 carbon atoms are preferred, and TDI, MDI, HDI, hydrogenated MDI, and IPDI are particularly preferred.

[Diamine Component]

As examples of the diamine (including tri- or more-valent polyamines used as necessary), as aliphatic diamines (C2 to C18), [1] aliphatic diamines {C2 to C6 alkylene diamines (ethylenediamine, propylenediamine, trimethylenediamine, tetramethylene diamine, hexamethylenediamine, and the like), polyalkylene (C2 to C6) diamines [diethylenetriamine, iminobispropylamine, bis(hexamethylene)triamine, triethylenetetramine, tetraethylenepentamine, pentaethylenehexamine, and the like]}; [2] alkyl (C1 to C4) or hydroxyalkyl (C2 to C4) substitution products of these [dialkyl (C1 to C3) aminopropylamine, trimethylhexamethylenediamine, aminoethylethanolamine, 2,5-dimethyl-2,5-hexamethylenediamine, methyliminobispropylamine, and the like]; [3] alicyclic or heterocycle-containing aliphatic diamines {alicyclic diamines (C4 to C15) [1,3-d]aminocyclohexane, isophorone diamine, menthene diamine, 4,4′-methylenedicyclohexanediamine (hydrogenated methylenedianiline), and the like], heterocyclic diamines (C4 to C15) [piperazine, N-aminoethylpiperazine, 1,4-diaminoethylpiperazine, 1,4 bis(2-amino-2-methylpropyl)piperazine, 3,9-bis(3-aminopropyl)-2,4,8,10-tetraoxaspiro[5,5]undecane, and the like]; [4] aromatic ring-containing aliphatic amines (C8 to C15) (xylylenediamine, tetrachloro-p-xylylenediamine, and the like); and the like can be recited.

As aromatic diamines (C6 to C20), [1] unsubstituted aromatic diamines [1,2-, 1,3- and 1,4-phenylenediamine, 2,4′- and 4,4′-diphenylmethanediamine, crude diphenylmethanediamine (polyphenylpolymethylenepolyamine), diaminodiphenylsulfone, benzidine, thiodianiline, bis(3,4-diaminophenyl)sulfone, 2,6-diaminopyridine, m-aminobenzylamine, triphenylmethane-4,4′,4″-triamine, naphthylenediamine, and the like; [2] aromatic diamines having a nuclear-substituted alkyl group [a C1 to C4 alkyl group such as methyl, ethyl, n- and i-propyl, and butyl), for example, 2,4- and 2,6-tolylene diamine, crude tolylene diamine, diethyltolylene diamine, 4,4′-diamino-3,3′-dimethyldiphenylmethane, 4,4′-bis(o-toluidine), dianisidine, diaminoditolylsulfone, 1,3-dimethyl-2,4-diaminobenzene, 1,3-dimethyl-2,6-diaminobenzene, 1,4-diisopropyl-2,5-diaminobenzene, 2,4-diaminomesitylene, 1-methyl-3,5-diethyl-2,4-diaminobenzene, 2,3-dimethyl-1,4-diaminonaphthalene, 2,6-dimethyl-1,5-diaminonaphthalene, 3,3′,5,5′-tetramethylbenzidine, 3,3′,5,5′-tetramethyl-4,4′-diaminodiphenylmethane, 3,5-diethyl-3′-methyl-2′,4-diaminodiphenylmethane, 3,3′-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraethyl-4,4′-diaminodiphenylether, 3,3′,5,5′-tetraisopropyl-4,4′-diaminodiphenylsulfone, and the like], and mixtures in various ratios of these isomers; [3] aromatic diamines having a nuclear-substituted electron-attracting group (a halogen such as Cl, Br, I, or F; an alkoxy group such as methoxy or ethoxy; a nitro group; or the like) [methylenebis-o-chloroaniline, 4-chloro-o-phenylenediamine, 2-chloro-1,4-phenylenediamine, 3-amino-4-chloroaniline, 4-bromo-1,3-phenylenediamine, 2,5-dichloro-1,4-phenylenediamine, 5-nitro-1,3-phenylenediamine, 3-dimethoxy-4-aminoaniline; 4,4′-diamino-3,3′-dimethyl-5,5′-dibromo-diphenylmethane, 3,3′-dichlorobenzidine, 3,3′-dimethoxybenzidine, bis(4-amino-3-chlorophenyl)oxide, bis(4-amino-2-chlorophenyl)propane, bis(4-amino-2-chlorophenyl)sulfone, bis(4-amino-3-methoxyphenyl)decane, bis(4-aminophenyl)sulfide, bis(4-aminophenyl)telluride, bis(4-aminophenyl)selenide, bis(4-amino-3-methoxyphenyl)disulfide, 4,4′-methylenebis(2-iodoaniline), 4,4′-methylenebis(2-bromoaniline), 4,4′-methylenebis(2-fluoroaniline), 4-aminophenyl-2-chloroaniline, and the like]; and [4] aromatic diamines having a secondary amino group [part or all of —NH₂ in the aromatic diamine of the above [1] to [3] is substituted with —NH—R′ (R′ is a lower alkyl group such as methyl or ethyl)][4,4′-di(methylamino)diphenylmethane, 1-methyl-2-methylamino-4-aminobenzene, and the like] can be recited.

As the diamine component, besides the above, polyamidepolyamines [a low molecular weight polyamidepolyamine obtained by condensation of a dicarboxylic acid (dimer acid, or the like) and excess (2 mol or more per 1 mol of an acid) polyamines (the above alkylene diamine, polyalkylenepolyamine, and the like), and the like], polyetherpolyamines [a hydride of a cyanoethylated polyetherpolyol (polyalkyleneglycol, and the like) and the like] and the like can be recited.

Among crystalline polyester resins, a lactone ring-opening polymer is obtained, for example, by ring-opening polymerization of lactones such as monolactones with 3 to 12 carbon atoms such as β-propiolactone, γ-butylolactone, δ-valerolactone, and ε-caprolactone (the number of ester groups in the ring is one) using a catalyst such as a metal oxide or an organic metal compound. Among these, a preferred lactone is ε-caprolactone from the viewpoint of crystallinity.

When a glycol is used as an initiator, a lactone ring-opening polymer having a hydroxyl group at a terminal is obtained. For example, it can be obtained by reacting the above lactones with the above diol components such as ethylene glycol and diethylene glycol in the presence of a catalyst. As a catalyst, an organic tin compound, an organic titanium compound, an organic halogenated tin compound, and the like are commonly used, and by adding the catalyst at a ratio of about 0.1 to 5000 ppm and allowing polymerization at 100 to 230° C. preferably in an inert atmosphere, it is possible to obtain a lactone ring-opening polymer. The lactone ring-opening polymer may be modified so that its terminal is a carboxyl group, for example. The lactone ring-opening polymer is a thermoplastic aliphatic polyester resin having high crystallinity. The lactone ring-opening polymer may be a commercially available product, and for example, H1P, H4, H5, H7, and the like (each being high crystalline polycaprolactone having a melting point of about 60° C. and a Tg of about −60° C.) of PLACCEL series manufactured by DAICEL CHEMICAL INDUSTRIES, LTD. can be recited.

Among crystalline polyester resins, while a polyhydroxycarboxylic acid can be obtained by direct dehydration condensation of a hydroxycarboxylic acid such as glycolic acid or lactic acid (L isomer, D isomer, or racemic modification), it is more preferred, from the viewpoint of adjustment of the molecular weight, to perform ring-opening polymerization of a cyclic ester with 4 to 12 carbon atoms (the number of ester groups in the ring is 2 to 3) corresponding to a dehydration condensate between two molecules or three molecules of a hydroxycarboxylic acid such as glycolide or lactide (L isomer, D isomer, or racemic modification) by using a catalyst such as a metal oxide or an organic metal compound. Among these, preferred cyclic esters are L-lactide and D-lactide from the viewpoint of crystallinity.

When a glycol is used as an initiator, a polyhydroxycarboxylic acid backbone having a hydroxyl group at its terminal is obtained. For example, the polyhydroxycarboxylic acid backbone is obtained by reacting the above cyclic ester and the above diol component such as ethylene glycol or diethylene glycol in the presence of a catalyst. As a catalyst, an organic tin compound, an organic titanium compound, an organic halogenated tin compound, and the like are commonly used, and by adding the catalyst at a ratio of about 0.1 to 5000 ppm and allowing polymerization at 100 to 230° C. preferably in an inert atmosphere, it is possible to obtain a polyhydroxycarboxylic acid. The polyhydroxycarboxylic acid may be modified in such a manner that its terminal is a carboxyl group.

As the polyether resin, crystalline polyoxyalkylene polyol, and the like can be recited.

The method of producing crystalline polyoxyalkylene polyol is not particularly limited, and any conventionally publicly known method may be used.

For example, a method of ring-opening polymerization of AO of a chiral body with a catalyst usually used in polymerization of AO (for example, described in Journal of the American Chemical Society, 1956, Vol. 78, No. 18, p. 4787-4792), and a method of ring-opening polymerization of inexpensive racemic AO by using a complex having a sterically bulky special chemical structure as a catalyst are known.

As a method using a special complex, a method using a compound obtained by bringing a lanthanoid complex and organic aluminum into contact with each other as a catalyst (for example, described in JP-A No. 11-12353) and a method of reacting bimetal μ-oxo alkoxide and a hydroxyl compound in advance (for example, described in Japanese Examined Patent Publication No. 2001-521957), and the like are known.

Further, as a method of obtaining polyoxyalkylene polyol having very high isotacticity, a method using a salen complex as a catalyst (described in Journal of the American Chemical Society, 2005, Vol. 127, No. 33, p. 11566-11567, for example) is known.

For example, when AO of a chiral body is used and a glycol or water is used as an initiator at the time of ring-opening polymerization, polyoxyalkylene glycol having a hydroxyl group at its terminal, having an isotacticity of 50% or more, is obtained. Polyoxyalkylene glycol having an isotacticity of 50% or more may be modified so that its terminal is a carboxyl group, for example. When the isotacticity is 50% or more, usually, the polyoxyalkylene glycol has crystallinity.

As the above glycol, the above diol component and the like can be recited, and as carboxylic acid used for carboxy modification, the above dicarboxylic acid component and the like can be recited.

As AO used for production of crystalline polyoxyalkylene polyol, those having 3 to 9 carbon atoms can be recited, and for example, the following compounds can be recited.

AO with 3 carbon atoms [PO, 1-chlorooxetane, 2-chlorooxetane, 1,2-dichlorooxetane, epichlorohydrin, epibromohydrin]; AO with 4 carbon atoms[1,2-BO, methylglycidyl ether]; AO with 5 carbon atoms [1,2-pentylene oxide, 2,3-pentylene oxide, 3-methyl-1,2-butylene oxide]; AO with 6 carbon atoms [cyclohexene oxide, 1,2-hexylene oxide, 3-methyl-1,2-pentylene oxide, 2,3-hexylene oxide, 4-methyl-2,3-pentylene oxide, allylglycidyl ether]; AO with 7 carbon atoms[1,2-heptylene oxide]; AO with 8 carbon atoms [styrene oxide]; AO with 9 carbon atoms [phenylglycidyl ether], and the like.

Among these AOs, PO, 1,2-BO, styrene oxide and cyclohexene oxide are preferred. PO, 1,2-BO and cyclohexene oxide are more preferred. From the viewpoint of polymerization speed, PO is most preferable.

These AOs may be used singly or in combination of two or more kinds.

The isotacticity of crystalline polyoxyalkylene polyol is preferably 70% or more, more preferably 80% or more, further preferably 90% or more, and most preferably 95% or more from the viewpoint of a high sharp melting property and blocking resistance of the crystalline polyether resin to be obtained.

The isotacticity can be calculated by the method described in Macromolecules, vol. 35, No. 6, pp. 2389-2392 (2002), and determined in the following manner.

About 30 mg of a measurement sample is weighed in a sample tube for ¹³C-NMR having a diameter of 5 mm, and added with about 0.5 mL of a deuterated solvent and dissolved therein, to prepare a sample for analysis. Here, the deuterated solvent is deuterated chloroform, deuterated toluene, deuterated dimethyl sulfoxide, deuterated dimethyl formamide or the like, and a solvent capable of dissolving a sample is appropriately selected.

Signals originated from three kinds of methine groups in ¹³C-NMR are respectively observed near a syndiotactic value (S) of 75.1 ppm, near a heterotactic value (H) of 75.3 ppm and near an isotactic value (I) of 75.5 ppm. The isotacticity is calculated by the following calculation formula (I).

Isotacticity(%)=[I/(I+S+H)]×100 (1)

(wherein, I is an integral value of an isotactic signal; S is an integral value of a syndiotactic signal; and H is an integral value of a heterotactic signal).

When the crystalline resin (A) is a block resin having the crystalline part (b) and the noncrystalline part (c), as a resin used for formation of the noncrystalline part (c), a polyester resin, a polyurethane resin, a polyurea resin, a polyamide resin, a polyether resin, a vinyl resin (polystyrene, a styrene acrylic polymer, or the like), a polyepoxy resin, and the like can be recited.

However, since the resin used for formation of the crystalline part (b) is preferably a polyester resin, a polyurethane resin, a polyurea resin, a polyamide resin, or a polyether resin, the resin used for formation of the noncrystalline part (c) is also preferably a polyester resin, a polyurethane resin, a polyurea resin, a polyamide resin, a polyether resin or a composite resin thereof in consideration of compatibility at the time of heating. A polyurethane resin and a polyester resin are more preferred.

These noncrystalline resins may have compositions similar to those of the crystalline part (b), and as a monomer for use, the above diol component, the above dicarboxylic acid component, the above diisocyanate component, the above diamine component, and the above AO can be recited as concrete examples, and any combination is applicable as far as it serves as a noncrystalline resin.

[Production Method of Block Polymer]

As to a block polymer composed of the crystalline part (b) and the noncrystalline part (c), whether a binder is used or not is selected in consideration of reactivity of each terminal functional group, and when a binder is used, a kind of the binder suited for the terminal functional group is selected, and (b) and (c) are bound to give a block polymer.

When a binder is not used, a reaction between a terminal functional group of a resin forming (b) and a terminal functional group of a resin forming (c) is allowed to proceed under heating and reduced pressure as necessary. In particular, in the case of a reaction between an acid and an alcohol or a reaction between an acid and an amine, when one of the resins has a high acid value and the other one of the resins has a high hydroxyl value or a high amine value, the reaction proceeds smoothly. The reaction temperature is preferably from 180° C. to 230° C.

When a binder is used, a variety of binders may be used. It can be obtained by a dehydration reaction or an addition reaction by using a polyvalent carboxylic acid, a polyhydric alcohol, a polyvalent isocyanate, a polyfunctional epoxy, an acid anhydride, or the like.

As the polyvalent carboxylic acid and the acid anhydride, those recited for the above dicarboxylic acid component can be recited. As the polyhydric alcohol, those recited for the above diol component can be recited. As the polyvalent isocyanate, those recited for the above diisocyanate component can be recited. As the polyfunctional epoxy, bisphenol A type and -F type epoxy compounds, phenol novolac-type epoxy compounds, cresol novolac-type epoxy compounds, hydrogenated bisphenol A-type epoxy compounds, diglycidyl ethers of AO adduct of bisphenol A or -F, diglycidyl ethers of AO adduct of hydrogenated bisphenol A, respective diglycidyl ethers of diols (ethylene glycol, propylene glycol, neopentyl glycol, butanediol, hexanediol, cyclohexanedimethanol, polyethylene glycol and polypropylene glycol, and the like), trimethylolpropane di- and/or triglycidyl ether, pentaerythritol tri- and/or tetraglycidyl ether, sorbitol hepta- and/or hexa glycidyl ether, resorcin diglycidyl ether, dicyclopentadiene•phenol addition type glycidyl ether, methylenebis(2,7-dihydroxynaphthalene)tetraglycidyl ether, 1,6-dihydroxynaphthalenediglycidyl ether, polybutadiene diglycidyl ether, and the like can be recited.

Among the methods of binding (b) and (c), as an example of a dehydration reaction, a reaction in which both the crystalline part (b) and the noncrystalline part (c) are resins having alcohols on both terminals, and these are bound with a binder (for example, a polyvalent carboxylic acid) can be recited. In this case, a reaction occurs, for example, in the absence of a solvent at a reaction temperature of 180° C. to 230° C., and a block polymer is obtained.

As an example of the addition reaction, a reaction in which both the crystalline part (b) and the noncrystalline part (c) are resins having a hydroxyl group at their terminals, and these are bound by a binder (for example, a polyvalent isocyanate), or a reaction in which one of the crystalline part (b) and the noncrystalline part (c) is a resin having a hydroxyl group at its terminal and the other one is a resin having an isocyanate group at its terminal, and these are bound without using a binder can be recited. In this case, for example, both the crystalline part (b) and the noncrystalline part (c) are dissolved in a solvent capable of dissolving both of them, added with a binder as necessary, and allowed to react at a reaction temperature of 80° C. to 150° C., to obtain a block polymer.

As the crystalline resin (A), while the above block polymer is preferred, a resin composed only of the crystalline part (b) and not having the noncrystalline part (c) may also be used.

As the composition of (A) composed only of the crystalline part, those similar to those recited for the above crystalline part (b), and a crystalline vinyl resin can be recited.

As the crystalline vinyl resin, the one formed of a vinyl monomer (m) having a crystalline group, and a vinyl monomer (n) not having a crystalline group as necessary, as constitutional units is preferred.

As the vinyl monomer (m), a straight-chain alkyl(meth)acrylate (m1) with 12 to 50 carbon atoms in the alkyl group (the straight-chain alkyl group with 12 to 50 carbon atoms is a crystalline group), and a vinyl monomer (m2) having a unit of the crystalline part (b) can be recited.

As the crystalline vinyl resin, the one having the straight-chain alkyl (meth)acrylate (m1) having an alkyl group with 12 to 50 (preferably 16 to 30) carbon atoms as the vinyl monomer (m) is further preferred.

As (m1), lauryl(meth)acrylate, tetradecyl(meth)acrylate, stearyl (meth)acrylate, eicosyl(meth)acrylate, and behenyl(meth)acrylate in which respective alkyl groups are straight-chained can be recited.

In the present invention, the alkyl(meth)acrylate means alkyl acrylate and/or alkyl methacrylate, and a similar notational system will be employed hereinafter.

In the vinyl monomer (m2) having a unit of the crystalline part (b), for introducing the unit of the crystalline part (b) into the vinyl monomer, whether a binder (coupling agent) is used or not is selected in consideration of reactivity of each terminal functional group, and when a binder (coupling agent) is used, a binder (coupling agent) suited for the terminal functional group is selected, and the crystalline part (b) and the vinyl monomer are bound together, to give the vinyl monomer (m2) having a unit of the crystalline part (b).

When a binder is not used at the time of production of the vinyl monomer (m2) having a unit of the crystalline part (b), a reaction between a terminal functional group of the crystalline part (b) and a terminal functional group of the vinyl monomer is allowed to proceed under heating and reduced pressure as necessary. Particularly in the case of a reaction between a carboxyl group and a hydroxyl group and a reaction between a carboxyl group and an amino group as the terminal functional groups, the reaction proceeds smoothly if the acid value of one of the resins is high, and the hydroxyl value or amine value of the other one of the resins is high. The reaction is preferably conducted at a temperature of 180° C. to 230° C.

When a binder (coupling agent) is used, various binders may be used in accordance with the kind of the terminal functional group.

As concrete examples of the binder (coupling agent), and a production method of the vinyl monomer (m2) using the binder (coupling agent), a method similar to the above production method of a block polymer can be recited.

Examples of the vinyl monomer (n) not having a crystalline group include, but are not limited to, a vinyl monomer (n1) having a molecular weight of not more than 1000 that is usually used in production of a vinyl resin other than the vinyl monomer (m) having a crystalline group, and a vinyl monomer (n2) having a unit of the above noncrystalline part (c).

As the vinyl monomer (n1), styrenes, (meth)acryl monomers, carboxyl group-containing vinyl monomers, other vinyl ester monomers, and aliphatic hydrocarbon-based vinyl monomers, and the like can be recited, and two or more kinds of them may be used together.

As the styrenes, styrene, alkylstyrenes having an alkyl group with 1 to 3 carbon atoms [for example, α-methylstyrene, p-methylstyrene] and the like can be recited, and styrene is preferred.

As the (meth)acryl monomer, alkyl(meth)acrylates having an alkyl group with 1 to 11 carbon atoms, and branched alkyl(meth)acrylates having an alkyl group with 12 to 18 carbon atoms [for example, methyl(meth)acrylate, ethyl(meth)acrylate, butyl(meth)acrylate, 2-ethylhexyl(meth)acrylate], hydroxylalkyl(meth)acrylates having an alkyl group with 1 to 11 carbon atoms [for example, hydroxylethyl(meth)acrylate], alkyl amino group-containing (meth)acrylates having an alkyl group with 1 to 11 carbon atoms [for example, dimethylaminoethyl(meth)acrylate, diethylaminoethyl(meth)acrylate], and nitrile group-containing vinyl monomers [for example, acrylonitrile, methacrylonitrile] and the like can be recited.

As the carboxyl group-containing vinyl monomer, monocarboxylic acids [having 3 to 15 carbon atoms, for example, (meth)acrylic acid, crotonic acid, cinnamic acid], dicarboxylic acids [having 4 to 15 carbon atoms, for example, (anhydrous) maleic acid, fumaric acid, itaconic acid, citraconic acid], dicarboxylic acid monoesters [monoalkyl (having 1 to 18 carbon atoms) esters of the above dicarboxylic acids, for example, maleic acid monoalkyl ester, fumaric acid monoalkyl ester, itaconic acid monoalkyl ester, citraconic acid monoalkyl ester] and the like can be recited.

As the other vinyl ester monomers, aliphatic vinyl esters [having 4 to 15 carbon atoms, for example, vinyl acetate, vinyl propionate, isopropenyl acetate], unsaturated carboxylic acid polyvalent (2 to 3- or more-valent) alcohol esters [having 8 to 50 carbon atoms, for example, ethylene glycol di(meth)acrylate, propylene glycol di(meth)acrylate, neopentyl glycol di(meth)acrylate, trimethylol propane tri(meth)acrylate, 1,6-hexanediol diacrylate, polyethylene glycol di(meth)acrylate], aromatic vinyl esters [having 9 to 15 carbon atoms, for example, methyl-4-vinyl benzoate] and the like can be recited.

As the aliphatic hydrocarbon-based vinyl monomers, olefins [having 2 to 10 carbon atoms, for example, ethylene, propylene, butene, octene], dienes [having 4 to 10 carbon atoms, for example, butadiene, isoprene, 1,6-hexadiene] and the like can be recited.

Among these (b1), a (meth)acryl monomer and a carboxyl group-containing vinyl monomer are preferred.

In the vinyl monomer (n2) having a unit of the noncrystalline part (c), as a method of introducing a unit of the noncrystalline part (c) into the vinyl monomer, a method similar to the above method of introducing a unit of the crystalline part (b) into the vinyl monomer in the vinyl monomer (m2) having a unit of the crystalline part (b) can be recited.

The percentage of the constitutional unit of the vinyl monomer (m) having a crystalline group in the crystalline vinyl resin is preferably 30% by weight or more, more preferably 35 to 95% by weight, and particularly preferably 40 to 90% by weight. When it is within this range, crystallinity of the vinyl resin is not impaired, and good heat resistant storage stability is achieved. The content of the straight-chain alkyl (meth)acrylate (m1) having an alkyl group with 12 to 50 carbon atoms in (m) is preferably 30 to 100% by weight, and more preferably 40 to 80% by weight. By polymerizing these vinyl monomers by a publicly known method, a crystalline vinyl resin is obtained.

As a toner binder of the present invention, the crystalline resin (A) may be used alone or together with a noncrystalline resin.

As the noncrystalline resin, for example, a polyester resin, a polyurethane resin, an epoxy resin or a vinyl resin having a number average molecular weight (hereinafter, referred to as Mn) of 1000 to 1000000, and combinational use thereof can be recited. A polyester resin and a vinyl resin are preferred, and a polyester resin is more preferred. However, from the viewpoint of low temperature fixability and image stability, the percentage of the crystalline resin (A) in the toner binder is preferably 80% by weight or more, more preferably 85% by weight or more, and further preferably 88% by weight or more.

The toner binder of the present invention may be mixed with a coloring agent to provide a toner of the present invention. A charge controller, a mold release agent, a fluidizing agent, and the like may further be added as necessary.

As the coloring agent, any dyes, pigments, and the like used as a coloring agent for toner may be used. Concretely, carbon black, iron black, Sudan Black SM, Fast yellow G, benzidine yellow, solvent yellow (21, 77, 114, and the like), pigment yellow (12, 14, 17, 83, and the like), Indofast orange, Irgazin red, para-nitoroaniline red, toluidine red, solvent red (17, 49, 128, 5, 13, 22, 48.2, and the like), disperse red, carmine FB, pigment orange R, Lake red 2G, Rhodamine FB, Rhodamine B Lake, methylviolet B Lake, phthalocyanine blue, solvent blue (25, 94, 60, 15.3, and the like), pigment blue, brilliant green, phthalocyanine green, oil yellow GG, Kayaset YG, Orasol brown B and Oil pink OP, and the like can be recited, and these may be used alone or in combination of two or more kinds. Also, magnetic powders (powders of ferromagnetic metals such as iron, cobalt and nickel, or compounds such as magnetite, hematite and ferrite) may be added for serving also as a coloring agent, as necessary. The content of the coloring agent is preferably 0.1 to 40 parts, more preferably 0.5 to 10 parts, with respect to 100 parts of the toner binder of the present invention. When a magnetic powder is used, the content is preferably 20 to 150 parts, and more preferably 40 to 120 parts. In the above and in the following, “part” means “part by weight”.

As the mold release agent, those having a softening point of 50 to 170° C. are preferred, and polyolefin wax, natural wax (for example, carnauba wax, montan wax, paraffin wax and rice wax), aliphatic alcohols with 30 to 50 carbon atoms (for example, triacontanol), fatty acids with 30 to 50 carbon atoms (for example, triacontane carboxylic acid) and mixtures thereof can be recited. As the polyolefin wax, (co)polymers of olefins (for example, ethylene, propylene, 1-buthene, isobutylene, 1-hexene, 1-dodecene, 1-octadecene and mixtures thereof) [including those obtained by (co)polymerization, and heat degradation-type polyolefins], oxides of (co)polymers of olefins by oxygen and/or ozone, maleic acid-modified products of (co)polymers of olefins [for example, modified products of maleic acid and its derivatives (maleic anhydride, monomethyl maleate, monobutyl maleate and dimethyl maleate)], copolymers of olefins and unsaturated carboxylic acids [(meth)acrylic acid, itaconic acid and maleic anhydride, and the like] and/or unsaturated carboxylic acid alkyl esters [(meth)acrylic acid alkyl (1 to 18 carbon atoms in alkyl) ester and maleic acid alkyl (1 to 18 carbon atoms in alkyl) ester, and the like], and polymethylene (for example, Fischer-Tropsch wax such as sasol wax), metal salts of fatty acids (calcium stearate, and the like), fatty acid esters (behenyl behenate, and the like), and the like can be recited.

As the charge controller, a nigrosine dye, a triphenylmethane dye containing a tertiary amine as a side chain, a quaternary ammonium salt, a polyamine resin, an imidazole derivative, a quaternary ammonium base-containing polymer, a metal-containing azo dye, a copper phthalocyanine dye, a metal salt of salicylic acid, a boron complex of benzylic acid, a sulfonic acid group-containing polymer, a fluorine-containing polymer, a halogen-substituted aromatic ring-containing polymer, a metal complex of an alkyl derivative of salicylic acid, cetyltrimethyl ammonium bromide, and the like can be recited.

As the fluidizing agent, colloidal silica, an alumina powder, a titanium oxide powder, a calcium carbonate powder, barium titanate, magnesium titanate, calcium titanate, strontium titanate, zinc oxide, silica sand, clay, mica, wollastonite, diatom earth, chromium oxide, cerium oxide, colcothar, antimony trioxide, magnesium oxide, zirconium oxide, barium sulfate, barium carbonate, and the like can be recited.

As to the composition ratio in making a toner, based on the weight of the toner (% in this item is % by weight in the following), the amount of a toner binder of the present invention is preferably 30 to 97%, more preferably 40 to 95%, and particularly preferably 45 to 92%; the amount of a coloring agent is preferably 0.05 to 60%, more preferably 0.1 to 55%, and particularly preferably 0.5 to 50%; among additives, the amount of a mold release agent is preferably 0 to 30%, more preferably 0.5 to 20%, and particularly preferably 1 to 10%; the amount of a charge controller is preferably 0 to 20%, more preferably 0.1 to 10%, and particularly preferably 0.5 to 7.5%; and the amount of a fluidizing agent is preferably 0 to 10%, more preferably 0 to 5%, and particularly preferably 0.1 to 4%. The total content of additives is preferably 3 to 70%, more preferably 4 to 58%, and particularly preferably 5 to 50%. With the composition ratio of the toner falling within the above range, those having excellent chargeability can be readily obtained.

The toner of the present invention may be obtained by any of conventionally publicly known methods such as a kneading and grinding method, an emulsion phase inversion method, and a polymerization method. For example, when a toner is obtained by a kneading and grinding method, after components constituting the toner excluding the fluidizing agent are dry blended, the components are melted and kneaded, and then roughly ground, and finally atomized with a jet mill grinder or the like, and further classified into microparticles having a volume average particle size (D50) of preferably 5 to 20 μm, and then mixed with the fluidizing agent, to produce a toner. The particle size (D50) is measured by using a Coulter counter [for example, product name: Multisizer III (manufactured by Coulter, Inc.)].

When a toner is obtained by an emulsion phase inversion method, after components constituting the toner excluding the fluidizing agent are dissolved or dispersed in an organic solvent, the mixture is emulsified, for example, by adding water, followed by separation and classification, to produce a toner. Also a method using organic microparticles as described in JP-A No. 2002-284881 may be used for production. The volume average particle size of the toner is preferably 3 to 15 μm.

The toner may be mixed with carrier particles {an iron powder, glass beads, a nickel powder, ferrite, magnetite and ferrite whose surface is coated with a resin (an acrylic resin and a silicone resin, and the like) and the like} as necessary and used as a developing agent of an electric latent image. Also, an electric latent image may be formed by friction with a charged blade or the like in place of carrier particles. The electric latent image is then fixed to a support (paper, a polyester film, and the like) by a publicly known heating roll fixing method or the like.

### EXAMPLES

The present invention will be further described by way of examples, however, the present invention is not limited to these examples. In the following description, “%” represents % by weight.

### Production Example 1

### Production of Crystalline Part b

In a reaction vessel equipped with a condenser tube, a stirrer and a nitrogen introducing tube, 159 parts of sebacic acid, 28 parts of adipic acid, 124 parts of 1,4-butanediol and 1 part of titanium dihydroxybis(triethanol aminate) as a condensation catalyst were charged, and allowed to react for 8 hours at 180° C. under a nitrogen gas flow while generated water was distilled off. Then a reaction was allowed for 4 hours under a nitrogen gas flow while the temperature was gradually elevated to 220° C. and generated water and 1,4-butanediol were distilled off, and further a reaction was allowed under a reduced pressure of 5 to 20 mmHg, and the product was taken out when the Mw reached 10000. The resin taken out was cooled to room temperature, and then ground into particles, to obtain a crystalline polycondensation polyester resin [crystalline part b1]. [Crystalline part b1] had a melting point of 55° C., an Mw of 10000, and a hydroxyl value of 36.

### Production Example 2

### Production of Crystalline Part b)

In a reaction vessel equipped with a condenser tube, a stirrer and a nitrogen introducing tube, 286 parts of dodecane diacid, 159 parts of 1,6-hexanediol and 1 part of titanium dihydroxybis(triethanol aminate) as a condensation catalyst were charged, and allowed to react for 8 hours at 170° C. under a nitrogen gas flow while generated water was distilled off. Then a reaction was allowed for 4 hours under a nitrogen gas flow while the temperature was gradually elevated to 220° C. and generated water was distilled off, and further a reaction was allowed under a reduced pressure of 5 to 20 mmHg, and the product was taken out when the Mw reached 10000. The resin taken out was cooled to room temperature, and then ground into particles, to obtain a crystalline polycondensation polyester resin [crystalline part b2]. [Crystalline part b2] had a melting point of 65° C., an Mw of 10000, and a hydroxyl value of 36.

### Production Example 3

### Production of Crystalline Part b

In a reaction container in which a stirring rod and a thermometer are provided, 66 parts of 1,4-butanediol, 86 parts of 1,6-hexanediol, and 40 parts of methyl ethyl ketone (hereinafter, referred to as MEK) were charged. This solution was charged with 248 parts of hexamethylene diisocyanate (HDI) and allowed to react at 80° C. for 5 hours, to obtain a solution of a crystalline polyurethane resin [crystalline part b3] in MEK. After removal of the solvent, [crystalline part b3] had a melting point of 57° C., an Mw of 9700, and a hydroxyl value of 36.

### Production Example 4

### Production of Crystalline Part b

In a reaction vessel equipped with a condenser tube, a stirrer and a nitrogen introducing tube, 159 parts of sebacic acid, 28 parts of adipic acid, 124 parts of 1,4-butanediol and 1 part of titanium dihydroxybis(triethanol aminate) as a condensation catalyst were charged, and allowed to react for 8 hours at 180° C. under a nitrogen gas flow while generated water was distilled off. Then a reaction was allowed for 4 hours under a nitrogen gas flow while the temperature was gradually elevated to 220° C. and generated water and 1,4-butanediol were distilled off, and further a reaction was allowed under a reduced pressure of 5 to 20 mmHg, and the product was taken out when the Mw reached 20000. The resin taken out was cooled to room temperature, and then ground into particles, to obtain a crystalline polycondensation polyester resin [crystalline part b4]. [Crystalline part b4] had a melting point of 55° C., an Mw of 20000, and a hydroxyl value of 19.

### Production Example 5

### Production of Crystalline Part b

In a reaction vessel equipped with a condenser tube, a stirrer and a nitrogen introducing tube, 159 parts of sebacic acid, 28 parts of adipic acid, 124 parts of 1,4-butanediol and 1 part of titanium dihydroxybis(triethanol aminate) as a condensation catalyst were charged, and allowed to react for 8 hours at 180° C. under a nitrogen gas flow while generated water was distilled off. Then a reaction was allowed for 2 hours under a nitrogen gas flow while the temperature was gradually elevated to 210° C. and generated water and 1,4-butanediol were distilled off, and further a reaction was allowed under a reduced pressure of 5 to 20 mmHg, and the product was taken out when the Mw reached 5000. The resin taken out was cooled to room temperature, and then ground into particles, to obtain a crystalline polycondensation polyester resin [crystalline part b5]. [Crystalline part b5] had a melting pint of 55° C., an Mw of 5000, and a hydroxyl value of 83.

### Production Example 6

### Production of Crystalline Part b

In a 1 L autoclave, 180 parts of (S)—PO. and 30 parts of KOH were put, and allowed to polymerize by stirring at room temperature for 48 hours. The obtained polymer was melted by elevating the temperature to 70° C., and each 100 parts of toluene and 100 parts of water were added and liquid separation was repeated three times for washing KOH with water. The resultant toluene phase was neutralized with 0.1 mol/L of hydrochloric acid, and each 100 parts of water was added and liquid separation were repeated three more times, and toluene was distilled off from the toluene phase. The obtained resin was cooled to room temperature, and ground into particles, to obtain a crystalline polyether resin [crystalline part b6]. [Crystalline part b6] had a melting point of 55° C., an Mw of 9000, a hydroxyl value of 20, and an isotacticity of 99%.

### Production Example 7

### Production of Crystalline Part b

In a reaction container equipped with a stirring apparatus and a dewatering apparatus, 2 parts of 1,4-butanediol, 650 parts of ε-caprolactone, and 2 parts of dibutyl tin oxide were charged, and allowed to react for 10 hours at 150° C. at normal pressure in a nitrogen atmosphere. Further, the obtained resin was cooled to room temperature, and ground into particles, to obtain a crystalline polyester resin [crystalline part b7] which is a lactone ring-opening polymer. [Crystalline part b7] had a melting point of 60° C., an Mw of 9800, and a hydroxyl value of 14.

### Production Example 8

### Production of Crystalline Part b

In a reaction container equipped with a stirring apparatus and a dewatering apparatus, 2 parts of ethylene glycol, 400 parts of L-lactide, 150 parts of glycolide, 2 parts of dibutyl tin oxide were charged, and allowed to react at 150° C. for 10 hours at normal pressure in a nitrogen atmosphere. Further, the obtained resin was cooled to room temperature, and ground into particles, to obtain a crystalline polyester resin [crystalline part b8] which is a polyhydroxycarboxylic acid. [Crystalline part b8] had a melting point of 60° C., an Mw of 11200, and a hydroxyl value of 14.

### Production Example 9

### Production of Crystalline Part b

In a reaction vessel equipped with a condenser tube, a stirrer and a nitrogen introducing tube, 121 parts of sebacic acid, 118 parts of dimethylterephthalic acid, 124 parts of 1,6-hexanediol and 1 part of titanium dihydroxybis(triethanol aminate) as a condensation catalyst were charged, and allowed to react at 180° C. for 8 hours under a nitrogen gas flow while generated water was distilled off. Then a reaction was allowed for 4 hours under a nitrogen gas flow while the temperature was gradually elevated to 220° C. and generated water and 1,6-hexanediol were distilled off, and further a reaction was allowed under a reduced pressure of 5 to 20 mmHg, and the product was taken out when the Mw reached 8000. The resin taken out was cooled to room temperature, and then ground into particles, to obtain a crystalline polycondensation polyester resin [crystalline part b9]. [Crystalline part b9] had a melting point of 53° C., an Mw of 8000, and a hydroxyl value of 46.

### Production Example 10

### Production of Noncrystalline Part c

In a reaction vessel equipped with a condenser tube, a stirrer and a nitrogen introducing tube, 831 parts of 1,2-propylene glycol (hereinafter, referred to as propylene glycol), 750 parts of terephthalic acid, and 0.5 parts of tetrabutoxy titanate as a condensation catalyst were charged, and allowed to react for 8 hours at 180° C. under a nitrogen gas flow while generated methanol was distilled off. Then a reaction was allowed for 4 hours under a nitrogen gas flow while the temperature was gradually elevated to 230° C. and generated propylene glycol and water were distilled off. Further a reaction was allowed under a reduced pressure of 5 to 20 mmHg, and the reaction was cooled to 180° C. when the softening point reached 87° C., and added with 24 parts of trimellitic anhydride and 0.5 parts of tetrabutoxy titanate, and allowed to react for 90 minutes, and then the product was taken out. The amount of the collected propylene glycol was 442 parts. The resin taken out was cooled to room temperature, and then ground into particles, to obtain a noncrystalline polycondensation polyester resin [noncrystalline part c1′]. [Noncrystalline part c1′] had an Mw of 8000, a Tg of 65° C., and a hydroxyl value of 30.

### Example 1

### Production of Crystalline Resin A (Toner Binder)

In a reaction container in which a stirring rod and a thermometer are provided, 44 parts of tolylene diisocyanate and 100 parts of MEK were charged. This solution was charged with 32 parts of cyclohexanedimethanol and allowed to react at 80° C. for 2 hours. Then the solution of a noncrystalline polyurethane resin [noncrystalline part c2] having an isocyanate group at its terminal was put into a solution obtained by dissolving 140 parts of [crystalline part b1] in 140 parts of MEK, and allowed to react at 80° C. for 4 hours, to obtain a solution of [crystalline resin A1] composed of a crystalline part and a noncrystalline part in MEK. After removing the solvent, [crystalline resin A1] had a Ta of 55° C., an Mn of 14000, and an Mw of 28000.

### Example 2

### Production of Crystalline Resin A (Toner Binder)

In a reaction container in which a stirring rod and a thermometer are provided, 38 parts of tolylene diisocyanate and 100 parts of MEK were charged. The resultant solution was charged with 14 parts of propylene glycol and allowed to react at 80° C. for 2 hours. Then the solution of a noncrystalline polyurethane resin [noncrystalline part c3] having an isocyanate group at its terminal was put into a solution obtained by dissolving 130 parts of [crystalline part b2] in 130 parts of MEK, and allowed to react at 80° C. for 4 hours, to obtain a solution of [crystalline resin A2] composed of a crystalline part and a noncrystalline part in MEK. After removing the solvent, [crystalline resin A2] had a Ta of 64° C., an Mn of 9000, and an Mw of 34000.

### Example 3

### Production of Crystalline Resin A (Toner Binder)

Into a solution obtained by dissolving 130 parts of [crystalline part b3] in 130 parts of MEK, 152 parts of a solution of [noncrystalline part c3] that was obtained in a similar manner to Example 2 was put, and allowed to react at 80° C. for 4 hours, to obtain a solution of [crystalline resin A3] composed of a crystalline part and a noncrystalline part in MEK. After removing the solvent, [crystalline resin A3] had a Ta of 54° C., an Mn of 12000, and an Mw of 37000.

### Example 4

### Production of Crystalline Resin A (Toner Binder)

Into a solution obtained by dissolving 250 parts of [crystalline part b4] in 250 parts of MEK, 176 parts of a solution of [noncrystalline part c2] that was obtained in a similar manner to Example 1 was put, and allowed to react at 80° C. for 4 hours, to obtain a solution of [crystalline resin A4] composed of a crystalline part and a noncrystalline part in MEK. After removing the solvent, [crystalline resin A4] had a Ta of 55° C., an Mn of 24000, and an Mw of 45000.

### Example 5

### Production of Crystalline Resin A (Toner Binder)

In a reaction container in which a stirring rod and a thermometer are provided, a solution obtained by dissolving 190 parts of [crystalline part b1] in 190 parts of MEK was charged, followed by addition of 9 parts of tolylene diisocyanate, and allowed to react at 80° C. for 4 hours, to obtain a solution of [crystalline resin A5] which is a crystalline polyurethane resin in MEK. After removing the solvent, [crystalline resin A5] had a Ta of 55° C., an Mn of 31000, and an Mw of 72000.

### Example 6

### Production of Crystalline Resin A (Toner Binder)

Into a solution obtained by dissolving 250 parts of [crystalline part b6] in 250 parts of MEK, 176 parts of a solution of [noncrystalline part c2] that was obtained in a similar manner to Example 1 was put, and allowed to react at 80° C. for 4 hours, to obtain a solution of [crystalline resin A6] composed of a crystalline part and a noncrystalline part in MEK. After removing the solvent, [crystalline resin A6] had a Ta of 64° C., an Mn of 15000, and an Mw of 36000.

### Example 7

### Production of Crystalline Resin A (Toner Binder)

In a reaction container in which a stirring rod and a thermometer are provided, 38 parts of tolylene diisocyanate and 100 parts of MEK were charged. This solution was charged with 28 parts of cyclohexanedimethanol and allowed to react at 80° C. for 2 hours. Then the solution of a noncrystalline polyurethane resin [noncrystalline part c4] having an isocyanate group at its terminal was put into a solution obtained by dissolving 250 parts of [crystalline part b7] in 250 parts of MEK, and allowed to react at 80° C. for 4 hours, to obtain a solution of [crystalline resin A7] composed of a crystalline part and a noncrystalline part in MEK. After removing the solvent, [crystalline resin A7] had a Ta of 59° C., an Mn of 10000, and an Mw of 22000.

### Example 8

### Production of Crystalline Resin A (Toner Binder)

Into a solution obtained by dissolving 250 parts of [crystalline part b8] in 250 parts of MEK, 166 parts of a solution of [noncrystalline part c4] obtained in a similar manner to Example 7 was put, and allowed to react at 80° C. for 4 hours, to obtain a solution of [crystalline resin A8] composed of a crystalline part and a noncrystalline part in MEK. After removing the solvent, [crystalline resin A8] had a Ta of 60° C., an Mn of 9000, and an Mw of 21000.

### Example 9

### Production of Crystalline Resin A (Toner Binder)

In a reaction container equipped with a stirring apparatus, a heating and cooling apparatus, a thermometer, a dropping funnel, and a nitrogen blowing tube, 500 parts of toluene was charged, and in a separate glass beaker, 350 parts of toluene, 120 parts of behenyl acrylate (an acrylate of an alcohol having a straight-chain alkyl group with 22 carbon atoms: BLEMMER VA (manufactured by NOF CORPORATION)), 20 parts of 2-ethylhexyl acrylate, 10 parts of methacrylic acid, and 7.5 parts of azobisisobutylonitrile (AIBN) were charged, stirred and mixed at 20° C. to prepare a monomer solution, which was charged into the dropping funnel After replacing a gas phase part of the reaction container with nitrogen, the monomer solution was dropped over 2 hours at 80° C. in a hermetically-sealed condition, and aged at 85° C. for 2 hours from the end of the dropping, and then toluene was removed over 3 hours at 130° C. under reduced pressure, to obtain [crystalline resin A9] which is a crystalline vinyl resin. [Crystalline resin A9] had a Ta of 56° C., an Mn of 68000, and an Mw of 89000.

### Example 10

### Production of Crystalline Resin A (Toner Binder)

In a reaction container in which a stirring rod and a thermometer are provided, 42 parts of tolylene diisocyanate and 100 parts of MEK were charged. This solution was charged with 31 parts of cyclohexanedimethanol and allowed to react at 80° C. for 2 hours. Then the solution of a noncrystalline polyurethane resin [noncrystalline part c5] having an isocyanate group at its terminal was put into a solution obtained by dissolving 126 parts of [crystalline part b9] in 140 parts of MEK, and allowed to react at 80° C. for 4 hours, to obtain a solution of [crystalline resin A10] composed of a crystalline part and a noncrystalline part in MEK. After removing the solvent, [crystalline resin A10] had a Ta of 52° C., an Mn of 10000, and an Mw of 22000.

### Example 11

### Production of Crystalline Resin A (Toner Binder)

In a reaction container in which a stirring rod and a thermometer are provided, 32 parts of xylene diisocyanate and 100 parts of MEK were charged. This solution was charged with 47 parts of bisphenol A•EO 2-mol adduct and allowed to react at 80° C. for 2 hours. Then the solution of a noncrystalline polyurethane resin [noncrystalline part c6] having an isocyanate group at its terminal was put into a solution obtained by dissolving 122 parts of [crystalline part b1] in 140 parts of MEK, and allowed to react at 80° C. for 4 hours, to obtain a solution of [crystalline resin A11] composed of a crystalline part and a noncrystalline part in MEK. After removing the solvent, [crystalline resin A11] had a Ta of 55° C., an Mn of 14000, and an Mw of 30000.

### Example 12

### Production of Crystalline Resin A (Toner Binder)

In a reaction container in which a stirring rod and a thermometer are provided, 35 parts of xylene diisocyanate and 100 parts of MEK were charged. This solution was charged with 52 parts of bisphenol A•EO 2-mol adduct and allowed to react at 80° C. for 2 hours. Then the solution of a noncrystalline polyurethane resin [noncrystalline part c7] having an isocyanate group at its terminal was put into a solution obtained by dissolving 111 parts of [crystalline part b1] in 140 parts of MEK, and allowed to react at 80° C. for 4 hours, to obtain a solution of [crystalline resin A12] composed of a crystalline part and a noncrystalline part in MEK. After removing the solvent, [crystalline resin A12] had a Ta of 52° C., an Mn of 18000, and an Mw of 38000.

### Example 13

### Production of Crystalline Resin A (Toner Binder)

In a reaction container in which a stirring rod and a thermometer are provided, the noncrystalline polycondensation polyester resin [noncrystalline part c1′] obtained in Production Example 10 and 100 parts of MEK were charged. This solution was charged with 7 parts of xylene diisocyanate and allowed to react at 80° C. for 2 hours. Then the solution of a urethane-modified product [noncrystalline part c1] of [noncrystalline part c1′] having an isocyanate group at its terminal was put into a solution obtained by dissolving 111 parts of [crystalline resin b1] in 140 parts of MEK, and allowed to react at 80° C. for 4 hours, to obtain a solution of [crystalline resin A13] composed of a crystalline part and a noncrystalline part in MEK. After removing the solvent, [crystalline resin A13] had a Ta of 55° C., an Mn of 25000, and an Mw of 51000.

### Comparative Example 1

### Production of Comparative Resin A′ (Toner Binder)

In a reaction vessel equipped with a condenser tube, a stirrer and a nitrogen introducing tube, 456 parts (9.0 mol) of bisphenol A•PO 2-mol adduct, 321 parts (7.0 mol) of bisphenol A•EO 2-mol adduct, 247 parts (10.0 mol) of terephthalic acid, and 3 parts of tetrabutoxy titanate were charged, and allowed to react for 5 hours at 230° C. under a nitrogen gas flow while generated water was distilled off. Next, the reaction was allowed under a reduced pressure of 5 to 20 mmHg, and the product was cooled to 180° C. when the acid value reached 2, added with 74 parts of (2.6 mol) trimellitic anhydride, and the product was taken out after a reaction of 2 hours under normal pressure in a hermetically-sealed condition, to obtain [comparative resin A′14] which is a noncrystalline resin. [Comparative resin A′14] had a Tg of 55° C., an Mn of 3500, and an Mw of 7500.

### Comparative Example 2

### Production of Comparative Resin A′ (Toner Binder)

In a reaction container in which a stirring rod and a thermometer are provided, 50 parts of tolylene diisocyanate and 100 parts of MEK were charged. This solution was charged with 38 parts of cyclohexanedimethanol and allowed to react at 80° C. for 2 hours. Then the solution of a noncrystalline polyurethane resin [noncrystalline part c8] having an isocyanate group at its terminal was put into a solution obtained by dissolving 113 parts of [crystalline part b5] in 110 parts of MEK, and allowed to react at 80° C. for 4 hours, to obtain a solution of [comparative resin A′15] composed of a crystalline part and a noncrystalline part in MEK. After removing the solvent, [comparative resin A′15] had a Ta of 52° C., an Mn of 6000, and an Mw of 13000.

### Comparative Example 3

### Production of Comparative Resin A′ (Toner Binder)

In a reaction container in which a stirring rod and a thermometer are provided, 59 parts of tolylene diisocyanate and 80 parts of MEK were charged. This solution was charged with 46 parts of cyclohexanedimethanol and allowed to react at 80° C. for 2 hours. Then the solution of a noncrystalline polyurethane resin [noncrystalline part c9] having an isocyanate group at its terminal was put into a solution obtained by dissolving 17 parts of [crystalline part b1] in 17 parts of MEK, and allowed to react at 80° C. for 4 hours, to obtain a [comparative resin A′16] composed of a crystalline part and a noncrystalline part. After removing the solvent, [comparative resin A′16] had a Ta of 45° C., an Mn of 12000, and an Mw of 26000.

### Comparative Example 4

### Production of Comparative Resin A′ (Toner Binder)

In a reaction container in which a stirring rod and a thermometer are provided, 9 parts of tolylene diisocyanate and 80 parts of MEK were charged. This solution was charged with 48 parts of a polyester resin having an Mw of 2000 formed of bisphenol A•PO 2-mol adduct and isophthalic acid, and allowed to react at 80° C. for 2 hours. Then the solution of a noncrystalline polyurethane resin [noncrystalline part c10] having an isocyanate group at its terminal was put into a solution obtained by dissolving 95 parts of [crystalline part b1] in 95 parts of MEK, and allowed to react at 80° C. for 4 hours, to obtain [comparative resin A′17] composed of a crystalline part and a noncrystalline part. After removing the solvent, [comparative resin A′17] had a Ta of 55° C., an Mn of 4400, and an Mw of 14000.

Toner binders produced in examples and comparative examples [crystalline resin (A) and comparative resin (A′)] were analyzed respectively by the above methods, and the results are summarized in Table 1 and Table 2.

When a toner binder had the noncrystalline part (c), the molecular weight, the glass transition point and the softening point of the noncrystalline part were measured for a part drawn out at the time of production of the noncrystalline part. When the noncrystalline part had an isocyanate group, an equivalent amount of methanol was added thereto to make the content of isocyanate 0 before measurement.

TABLE 1

| | | Example | | | | | | | | |
|---|---|---|---|---|---|---|---|---|---|---|
| | | 1 | 2 | 3 | 4 | 5 | 6 | 7 | 8 | 9 |
| Toner binder | No. | A1 | A2 | A3 | A4 | A5 | A6 | A7 | A8 | A9 |
| | Ta [° C.] | 55 | 64 | 54 | 55 | 55 | 64 | 59 | 60 | 56 |
| | Softening point [° C.] | 63 | 70 | 64 | 61 | 51 | 71 | 68 | 61 | 63 |
| | Softening point/Ta | 1.15 | 1.09 | 1.19 | 1.11 | 0.93 | 1.11 | 1.15 | 1.02 | 1.13 |
| | Number average molecular weight | 14000 | 9000 | 12000 | 24000 | 31000 | 15000 | 10000 | 9000 | 68000 |
| | Weight average molecular weight | 28000 | 34000 | 37000 | 45000 | 72000 | 36000 | 22000 | 21000 | 89000 |
| | G′(Ta + 20) [Pa] | 5 × 10² | 1 × 10² | 9 × 10⁴ | 8 × 10² | 4 × 10³ | 1 × 10² | 6 × 10² | 7 × 10² | 5 × 10³ |
| | ΔLogG″ (*1) | 3.8 | 4.7 | 2.6 | 3.6 | 3.8 | 4.4 | 2.8 | 2.9 | 3.2 |
| | Melting start temperature (X) [° C.] | 45 | 55 | 45 | 45 | 45 | 56 | 48 | 48 | 48 |
| | (b)/(A) [%] | 65 | 71 | 71 | 77 | — | 77 | 79 | 79 | — |
| | (A) in toner binder [%] | 88 | 88 | 88 | 88 | 88 | 88 | 88 | 88 | 88 |
| | G″ ratio (*2) | 1.4 | 0.8 | 1.2 | 1.4 | 1.1 | 0.9 | 1.4 | 1.3 | 1.3 |
| | n value (*3) | 1.18 | 1.20 | 1.20 | 1.11 | — | 1.17 | 1.08 | 1.08 | — |
| Crystalline | No. | b1 | b2 | b3 | b4 | — | b6 | b7 | b8 | — |
| part (b) | Melting point [° C.] | 55 | 65 | 57 | 55 | — | 55 | 60 | 60 | — |
| | Weight average molecular weight | 10000 | 10000 | 9700 | 20000 | — | 9000 | 9800 | 11200 | — |
| | Hydroxyl value | 36 | 36 | 36 | 19 | — | 20 | 14 | 14 | — |
| | [mgKOH/g] | | | | | | | | | |
| Noncrystalline | No. | c2 | c3 | c3 | c2 | | c2 | c4 | c4 | |
| part (c) | Weight average molecular weight | 2000 | 1500 | 1500 | 2000 | — | 2000 | 2000 | 2000 | — |
| | Glass transition point [° C.] | 120 | 110 | 110 | 120 | — | 120 | 120 | 120 | — |
| | Softening point [° C.] | 200 | 170 | 170 | 200 | — | 200 | 200 | 200 | — |

*1: |LogG″(X + 20) − logG″(X)|
*2: G″(Ta + 30)/G″(Ta + 70)
*3: The number of n when the crystalline resin (A) has a block structure [(b) − {(c) − (b)}n], calculated from the charging amount (the molecular weight of the crystalline part is calculated from the hydroxyl value).

TABLE 2

| | | Example | | | | Comparative Example | | | |
|---|---|---|---|---|---|---|---|---|---|
| | | 10 | 11 | 12 | 13 | 1 | 2 | 3 | 4 |
| Toner binder | No. | A10 | A11 | A12 | A13 | A′14 | A′15 | A′16 | A′17 |
| | Ta [° C.] | 52 | 55 | 52 | 55 | — | 52 | 45 | 55 |
| | Softening point [° C.] | 52 | 60 | 62 | 62 | 108 | 82 | 92 | 56 |
| | Softening point/Ta | 1.00 | 1.09 | 1.19 | 1.13 | 1.96 | 1.58 | 2.04 | 1.02 |
| | Number average molecular weight | 10000 | 14000 | 18000 | 25000 | 3500 | 6000 | 12000 | 4400 |
| | Weight average molecular weight | 22000 | 30000 | 38000 | 51000 | 7500 | 13000 | 26000 | 14000 |
| | G′(Ta + 20) [Pa] | 9 × 10⁴ | 5 × 10⁴ | 3 × 10³ | 4 × 10³ | 2 × 10⁶ | 3 × 10² | 6 × 10⁶ | 3 × 10 |
| | ΔLogG″ (*1) | 3.6 | 3.0 | 2.6 | 4.8 | 1.6 | 1.9 | 1.6 | 4.5 |
| | Melting start temperature (X) [° C.] | 46 | 48 | 53 | 50 | 45 | 40 | 40 | 50 |
| | (b)/(A) [%] | 64 | 60 | 55 | 61 | — | 54 | 14 | 63 |
| | (A) in toner binder [%] | 88 | 88 | 88 | 88 | 88 | 88 | 88 | 88 |
| | G″ ratio (*2) | 1.1 | 2.5 | 4.2 | 8.8 | 300.0 | 25.0 | 68.0 | 1.3 |
| | n value (*3) | 1.20 | 1.32 | 1.42 | 1.23 | — | 2.89 | 1.09 | 1.07 |
| Crystalline | No. | b9 | b1 | b1 | b1 | — | b5 | b1 | b1 |
| part (b) | Melting point [° C.] | 53 | 55 | 55 | 55 | — | 55 | 55 | 55 |
| | Weight average molecular weight | 8000 | 10000 | 10000 | 10000 | — | 5000 | 10000 | 10000 |
| | Hydroxyl value | 46 | 36 | 36 | 36 | — | 83 | 36 | 36 |
| | [mgKOH/g] | | | | | | | | |
| Noncrystalline | No. | c5 | c6 | c7 | c1 | — | c8 | c9 | c10 |
| part (c) | Weight average molecular weight | 3000 | 2500 | 2500 | 8000 | — | 2700 | 21000 | 2000 |
| | Glass transition point [° C.] | 130 | 110 | 110 | 65 | — | 110 | 120 | 50 |
| | Softening point [° C.] | 180 | 170 | 170 | 105 | — | 210 | 270 | 82 |

*1: |LogG″(X + 20) − logG″(X)|
*2: G″(Ta + 30)/G″(Ta + 70)
*3: The number of n when the crystalline resin (A) has a block structure [(b) − {(c) − (b)}n], calculated from the charging amount (the molecular weight of the crystalline part is calculated from the hydroxyl value).

### Production Example 11

### Production of Coloring Agent Dispersion Liquid

In a beaker, 20 parts of copper phthalocyanine, 4 parts of a coloring agent dispersant (SOLSPERSE 28000; manufactured by Avecia Co., Ltd.), and 76 parts of ethyl acetate were charged, and uniformly dispersed by stirring, and then copper phthalocyanine was micro-dispersed by a beads mill, to obtain [coloring agent dispersion liquid 1]. The volume average particle size of [coloring agent dispersion liquid 1] measured by a particle size measuring apparatus LA-920 manufactured by HORIBA, Ltd. was 0.3 μm.

### Production Example 12

### Production of Modified Wax

In an autoclave reaction vessel equipped with a thermometer and a stirrer, 454 parts of xylene, and 150 parts of low molecular weight polyethylene (SANWAX LEL-400 manufactured by Sanyo Chemical Industries, Ltd.: softening point 128° C.) were charged, and sufficiently dissolved by elevating the temperature to 170° C. after nitrogen replacement, and a mixed solution of 595 parts of styrene, 255 parts of methyl methacrylate, 34 parts of di-t-butylperoxyhexahydro terephthalate, and 119 parts of xylene was added dropwise at 170° C. for 3 hours to cause polymerization, and the reaction was further retained at this temperature for 30 minutes. Next, the solvent was removed and [modified wax 1] was obtained. [Modified wax 1] had an Mn of 1872, an Mw of 5194, and a Tg of 56.9° C.

### Production Example 13

### Production of Wax Dispersion Liquid

In a reaction container equipped with a thermometer and a stirrer, 10 parts of paraffin wax (melting point 73° C.), 1 part of [modified wax 1], and 33 parts of ethyl acetate were charged, sufficiently dissolved by heating to 78° C., and cooled to 30° C. over 1 hour to precipitate the wax in the form of microparticles, which were then wet ground by using Ultra Visco Mill (manufactured by AIMEX CO., LTD.) to obtain [wax dispersion liquid 1].

### Production Example 14

### Production of Aqueous Dispersion Liquid of Microparticles (W)

In a reaction container equipped with a stirring rod and a thermometer, 130 parts of isopropanol was charged, and a mixed solution of 10 parts of butyl acrylate, 67 parts of vinyl acetate, 15 parts of maleic anhydride, 6 parts of sodium methacryloyloxy polyoxyalkylene sulfate (Eleminol RS-30, manufactured by Sanyo Chemical Industries, Ltd.), and 2 parts of benzoyl peroxide (containing 25% of water) was dropped over 120 minutes under stirring to cause polymerization. Then, 50 parts of this polymer solution was further added dropwise to 60 parts of ion exchange water under stirring, to obtain an aqueous dispersion liquid [microparticle dispersion liquid W1] containing polymer microparticles (W). The volume average particle size of [microparticle dispersion liquid W1] measured by both LA-920 and an electrophoretic light scattering photometer ELS-800 manufactured by Otsuka Electronics Co., Ltd. was 0.10 μm. Part of [microparticle dispersion liquid W1] was dried and the resin content was isolated. The Tg by DSC measurement of the resin content was 71° C.

The microparticles (W) are used for uniformizing the particle size of resin particles.

### Production Example 15

### Production of toner binder solution

In a reaction container equipped with a thermometer and a stirrer, 10 parts of [crystalline resin A1], 5 parts of MEK and 5 parts of ethyl acetate were charged, and warmed to 70° C. and stirred for making these be uniformly dispersed, followed by cooling to room temperature to obtain [toner binder solution A1].

### Production Example 16

### Production of Toner Binder Solution

[Toner binder solution A2] to [toner binder solution A13] were obtained in a similar manner to Production Example 15 except that [crystalline resin A2] to [crystalline resin A13] were respectively used in place of [crystalline resin A1].

### Comparative Production Example 1

### Production of Toner Binder Solution for Comparison

[Comparative toner binder solution A′14] to [comparative toner binder solution A′17] were obtained in a similar manner to Production Example 15 except that [comparative resin A′14] to [comparative resin A′17] were respectively used in place of [crystalline resin A1].

### Example 14

### Production of Particulate Toner

In a beaker, 60 parts of [toner binder solution A1], 27 parts of [wax dispersion liquid 1], and 10 parts of [coloring agent dispersion liquid 1] were charged, and stirred with a TK-type homomixer at 8,000 rpm at 50° C. so that they are dissolved and dispersed uniformly, to obtain [resin solution 1A].

In a beaker, 97 parts of ion exchange water, 10.5 parts of [microparticle dispersion liquid W1], 1 part of carboxymethyl cellulose sodium, and 10 parts of a 48.5% aqueous solution of sodium dodecyldiphenylether disulfonate (manufactured by Sanyo Chemical Industries, Ltd., Eleminol MON-7) were added and dissolved uniformly. Then 75 parts of [resin solution 1A] was charged under stirring with a TK-type homomixer at 10,000 rpm at 25° C. and stirred for 2 minutes. Then this mixture was transferred to a flask equipped with a stirring rod and a thermometer, and ethyl acetate was distilled off until the temperature was elevated and the concentration at 35° C. was 0.5% or less, to obtain an aqueous resin dispersion (XF1) of resin particles in which a coating film derived from the microparticles (W) is formed on the surface of resin particles containing the crystalline resin A1. After adjusting the pH of the aqueous resin dispersion (XF1) to 9.0 by adding an aqueous sodium hydroxide solution, the dispersion was heated to 50° C. and stirred for 1 hour to remove the coating film derived from (W) from the resin particles. After allowing the product to cool to room temperature, filtration and drying at 40° C. for 18 hours were conducted, to obtain a particulate toner (F1) containing the crystalline resin A1.

### Examples 15 to 26

### Production of Particulate Toner

Particulate toners (F2) to (F13) were obtained in a similar manner to Example 14 except that [toner binder solution A2] to [toner binder solution A13] were respectively used in place of [toner binder solution A1].

### Comparative Examples 5 to 8

### Production of Comparative Particulate Toner

Comparative particulate toners (F′14) to (F′17) were obtained in a similar manner to Example 14 except that [comparative toner binder solution A′14] to [comparative toner binder solution A′17] were respectively used in place of [toner binder solution A1].

Physical Property Measurement Examples

For the particulate toners (F1) to (F13), and the comparative particulate toners (F′14) to (F′17) obtained in Examples 14 to 26 and Comparative Examples 5 to 8, low temperature fixability and heat resistant storage stability were measured by the following methods. The results are shown in Table 3 and Table 4 below.

[Low Temperature Fixability]

A particulate toner was added with 1.0% of AEROSIL R972 (manufactured by Nippon Aerosil Co., Ltd.) and homogenized by mixing well, and the resultant powder was placed uniformly on a paper surface at 0.6 mg/cm². Here, the method of placing the powder onto the paper surface employs a printer from which a heat fixing machine is removed (other methods may be used as far as the powder can be placed uniformly at the above weight density). The MFT (minimum fixing temperature) when the paper was passed through a compression roller at a fixing speed (compression roller circumferential speed) of 213 mm/sec and a fixing pressure (compression roller pressure) of 5 kg/cm² was measured.

The mark “none” in the MFT section indicates absence of the fixing region.

[Heat Resistant Storage Stability]

A particulate toner was kept still for 15 hours in a dryer whose temperature was controlled to 50° C., and evaluation was made according to the following criteria by the degree of blocking.

good: blocking did not occur

acceptable: blocking occurred, but easily dispersed by applying force

poor: blocking occurred, and did not disperse by applying force

TABLE 3

| | Example | | | | | | | | |
|---|---|---|---|---|---|---|---|---|---|
| | 14 | 15 | 16 | 17 | 18 | 19 | 20 | 21 | 22 |
| Toner | F1 | F2 | F3 | F4 | F5 | F6 | F7 | F8 | F9 |
| No. | | | | | | | | | |
| MFT | 85 | 95 | 90 | 85 | 90 | 95 | 100 | 85 | 100 |
| Heat | Good | Good | Good | Good | Good | Good | Good | Good | Good |
| resistant | | | | | | | | | |
| storage | | | | | | | | | |
| stability | | | | | | | | | |

TABLE 4

| | Example | | | | Comparative Example | | | |
|---|---|---|---|---|---|---|---|---|
| | 23 | 24 | 25 | 26 | 5 | 6 | 7 | 8 |
| Toner No. | F10 | F11 | F12 | F13 | F′14 | F′15 | F′16 | F′17 |
| MFT | 90 | 100 | 100 | 100 | 130 | 130 | 120 | none |
| Heat | Good | Good | Good | Good | Good | Good | Poor | Good |
| resistant | | | | | | | | |
| stability | | | | | | | | |
| storage | | | | | | | | |

As shown in Table 3 and Table 4, toners of the present invention (Examples 14 to 26) are superior to toners of comparative examples (Comparative Examples 5 to 8) in either of low temperature fixability (MFT) and heat resistant storage stability (blocking resistance), and significantly good results were obtained particularly in the point of MFT.

### INDUSTRIAL APPLICABILITY

A toner of the present invention using a toner binder of the present invention is useful as a toner for electrostatic charge development having excellent low temperature fixability and blocking resistance.

1. A toner binder containing a crystalline resin (A) having a maximum peak temperature of heat of fusion (Ta) of 40 to 100° C., a ratio between the softening point and Ta (softening point/Ta) of 0.8 to 1.55, and a melting start temperature (X) within a temperature range of (Ta±30)° C., and satisfying the following requirements:
[Requirement 1] G′(Ta+20)=50 to 1×10⁶ [Pa]
[Requirement 2] |log G″(X+20)−log G″(X)|>2.0
[G′: storage elastic modulus [Pa], G″: loss elastic modulus [Pa]].

2. The toner binder according to claim 1, wherein a ratio [G″(Ta+30)/G″(Ta+70)] between the loss elastic modulus G″(Ta+30) at (Ta+30)° C. and the loss elastic modulus G″(Ta+70) at (Ta+70)° C. of the crystalline resin (A) is 0.05 to 50.

3. The toner binder according to claim 1, wherein the content of the crystalline resin (A) is 80% by weight or more.

4. The toner binder according to claim 1, wherein the crystalline resin (A) is a block resin composed of a crystalline part (b) and a noncrystalline part (c), the weight average molecular weight of (b) is 2000 to 80000, and the percentage of (b) in (A) is 50% by weight or more.

5. The toner binder according to claim 4, wherein the crystalline resin (A) is a resin in which the crystalline part (b) and the noncrystalline part (c) are linearly bound in the form of (b){−(c)−(b)}n, and n is 0.9 to 3.5.

6. The toner binder according to claim 4, wherein the noncrystalline part (c) has a glass transition point ranging from 40 to 250° C., and a softening point ranging from 100 to 300° C.

7. The toner binder according to claim 4, wherein the crystalline part (b) is a resin selected from a polyester resin, a polyurethane resin, a polyurea resin, a polyamide resin, a polyether resin, and composite resins thereof.

8. The toner binder according to claim 4, wherein the noncrystalline part (c) is a resin selected from a polyester resin, a polyurethane resin, a polyurea resin, a polyamide resin, a polyether resin, and composite resins thereof.

9. The toner binder according to claim 1, wherein the crystalline resin (A) is a crystalline vinyl resin having a vinyl monomer (m) having a crystalline group, and optionally a vinyl monomer (n) not having a crystalline group as a constitutional unit.

10. A toner containing the toner binder according to claim 1, and a coloring agent.

11. The toner according to claim 10, further containing at least one additive selected from a mold release agent, a charge controller and a fluidizing agent.
